(19) United States
(12) Patent Application Publication
(10) Pub. No.: US 2025/0361926 A1
(43) Pub. Date: Nov. 27, 2025

(54) CONTINUOUSLY VARIABLE TRANSMISSION WITH A SELF-ALIGNING DRIVEN CLUTCH

(71) Applicant: TEAM Industries, Inc., Bagley, MN (US)

(72) Inventors: Brian George Eck, Bemidji, MN (US); Shane Clair Okeson, Bagley, MN (US)

(73) Assignee: TEAM Industries, Inc., Bagley, MN (US)

(21) Appl. No.: 19/196,076

(22) Filed: May 1, 2025

Related U.S. Application Data
(60) Provisional application No. 63/650,661, filed on May 22, 2024.

(51) Int. Cl. F16H 9/12; F16H 9/18

(52) U.S. Cl. CPC F16H 9/125; F16H 9/18

(57) ABSTRACT

A self-aligning driven clutch is provided that includes a self-aligning return system. The self-aligning return system includes a driven post sleeve and a driven sleeve biasing member. The driven post sleeve is slidably mounted on a driven post in an axially movable arrangement. The driven sleeve biasing member is positioned to exert a biasing force on the driven post sleeve relative to a driven post to a home belt alignment position. A driven fixed sheave is mounted on the driven post sleeve of the self-aligning return system in an axially fixed arrangement. A driven moveable sheave is slidably mounted on the driven post sleeve of the self-aligning return system in an axially movable arrangement. A driven moveable sheave actuation system moves the driven movable sheave in relation to the driven fixed sheave on the driven post sleeve based on at least a force experienced by the self-aligning driven clutch.

### CROSS-REFERENCE TO RELATED APPLICATIONS

This application claims priority to U.S. Provisional Application Ser. No. 63/650,661, same title herewith, filed on May 22:2024, which is incorporated in its entirety herein by reference.

### BACKGROUND

A continuously variable transmission (CVT) includes a primary clutch or sheave (drive clutch) and a secondary clutch or sheave (driven clutch). The drive clutch is typically in operational communication with an engine/motor to receive engine torque and the driven clutch is in operational communication with a driveline of an associated vehicle. The driven clutch is in torsional communication with the drive clutch via an endless looped member such as a belt. The drive clutch includes a movable sheave assembly that is configured to move axially on a post as rotational speed and centrifugal forces increase and decrease. The movable sheave assembly axially moves on the post either away from or towards a fixed sheave. The belt, riding on faces of the fixed and movable sheave assemblies move radially either towards a central axis of the drive clutch or away from the central axis therein changing the gear ratio of the CVT.

In at least some CVTs, as the ratio of the CVT adjusts from idle to full speed, the belt on the drive sheave of the CVT walks inwards a small distance towards the engine. This movement of the belt on the drive clutch may cause misalignment of the belt at the driven clutch. To address the potential misalignment of the belt in this situation, a floated driven clutch may be used that is designed to move axially to follow the axial movement of the belt. In some operational situations encountered in a CVT using a floated driven clutch design, the floated clutch may not follow the belt as desired. For example, when the CVT adjusts from a high gear ratio back to an idle at a coast stop, the floated cutch may not follow the belt. A misalignment of the drive clutch and driven clutch of the CVT can lead to enhanced drag induced on the belt which may result in poor performance of the CVT and undue wear on the belt.

For the reasons stated above and for other reasons stated below which will become apparent to those skilled in the art upon reading and understanding the present specification, there is a need in the art for CVT that effectively and efficiently addresses belt misalignment situations.

### SUMMARY

The following summary is made by way of example and not by way of limitation. It is merely provided to aid the reader in understanding some of the aspects of the subject matter described. Embodiments provide a self-aligning driven clutch that includes a self-aligning return system that allows the driven clutch to follow axial belt movement caused by the drive clutch of the CVT.

In one embodiment, a self-aligning driven clutch that includes a driven post, a self-aligning return system, a driven fixed sheave, and driven movable sheave is provided. The self-aligning return system includes a driven post sleeve, and a driven sleeve biasing member. The driven post sleeve is slidably mounted on the driven post in an axially movable arrangement. The driven post sleeve has a first end and a second end. The driven sleeve biasing member is positioned to exert a biasing force on the driven post sleeve relative to the driven post to a home belt alignment position. The driven fixed sheave is mounted on the driven post sleeve of the self-aligning return system in an axially fixed arrangement. The driven moveable sheave slidably is mounted on the driven post sleeve of the self-aligning return system in an axially movable arrangement. The driven moveable sheave actuation system is configured to move the driven movable sheave on the driven post sleeve to selectively distance the driven movable sheave from the driven fixed sheave based on at least a force experienced by the self-aligning driven clutch.

In another embodiment, a continuously variable transmission including a drive clutch and a driven clutch is provided. The drive clutch is configured to receive engine torque from a motor. The driven clutch is in rotational communication with the drive clutch via endless looped member. The driven clutch is configured to pass torque to a drivetrain. The driven clutch includes a driven post and a self-aligning return system. The self-aligning return system includes a driven post sleeve and a driven sleeve. The driven post sleeve is slidably mounted on the driven post in an axially movable arrangement. The driven post sleeve has a first end and a second end. A driven sleeve biasing member is positioned to exert a biasing force on the driven post sleeve relative to the driven post to a home belt alignment position. A driven fixed sheave is mounted on the driven post sleeve of the self-aligning return system in an axially fixed arrangement. A driven moveable sheave is slidably mounted on the driven post sleeve of the self-aligning return system in an axially movable arrangement. A driven moveable sheave actuation system is configured to move the driven movable sheave on the driven post sleeve to selectively distance the driven movable sheave from the driven fixed sheave based on at least a force experienced by the self-aligning driven clutch.

In yet another embodiment, a vehicle that includes a motor, a drivetrain and continuously variable transmission is provided. The motor is used to generate engine torque. The continuously variable transmission includes a drive clutch and the driven clutch. The drive clutch is configured to receive the engine torque from the motor. The driven clutch is in rotational communication with the drive clutch via endless looped member. The driven clutch is configured to pass torque to the drivetrain. The driven clutch includes a driven post and a self-aligning return system. The self-aligning return system includes a driven post sleeve, a driven sleeve biasing member, a driven fixed sheave, a driven moveable sheave and a driven moveable sheave actuation system. The driven post sleeve is slidably mounted on the driven post in an axially movable arrangement. The driven post sleeve has a first end and a second end. The driven sleeve biasing member is positioned to exert a biasing force on the driven post sleeve relative to the driven post to a home belt alignment position. The driven fixed sheave is mounted on the driven post sleeve of the self-aligning return system in an axially fixed arrangement. The driven moveable sheave is slidably mounted on the driven post sleeve of the self-aligning return system in an axially movable arrangement. The driven moveable sheave actuation system is configured to move the driven movable sheave on the driven post sleeve to selectively distance the driven movable sheave from the driven fixed sheave based on at least a force experienced by the self-aligning driven clutch.

### BRIEF DESCRIPTION OF THE DRAWINGS

The present invention can be more easily understood and further advantages and uses thereof will be more readily apparent, when considered in view of the detailed description and the following figures in which:

FIG. 1 is a side view of a CVT with a self-aligning driven clutch according to an example aspect of the present invention;

FIG. 2A is a top view of the CVT with the self-aligning driven clutch of FIG. 1 in a high gear configuration;

FIG. 2B is a cross-sectional top view of the CVT with the self-aligning driven clutch according to an example aspect of the present invention. The drive clutch of the CVT in FIG. 2B is in a high gear configuration in this illustration;

FIG. 2C is a cross-sectional top view of the CVT of FIG. 2B with the self-aligning driven clutch. The drive clutch of the CVT in FIG. 2C is in an idle configuration;

FIG. 3 is a partial unassembled side perspective view of a driven clutch according to an example aspect of the present invention;

FIG. 4A is a cross sectional side view of a driven clutch in a first configuration according to one example aspect of the present invention;

FIG. 4B is a close up cross-sectional partial view of the self-aligning return system of the driven clutch in the configuration of FIG. 4A;

FIG. 5A is a cross sectional side view of a driven clutch in a second configuration according to one example aspect of the present invention;

FIG. 5B is a close up cross-sectional partial view of the self-aligning return system of the driven clutch in the configuration of FIG. 5A;

FIG. 5C is a close up cross-sectional partial view of a self-aligning return system of a driven clutch according to one example aspect of the present invention; and

FIG. 6 is a block view of a vehicle including a self-aligning driven clutch according to one example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a continuously variable transmission (CVT) with a self-aligning driven clutch. Embodiments of the self-aligning driven clutch include a self-aligning return system that allows the self-aligning driven clutch to follow a drive clutch of the CVT to keep a belt that communicates torque between the drive clutch and driven clutch aligned. The self-aligning return system described herein addresses belt misalignment experienced on fixed driven clutch systems (systems with no float). The alignment system provided by the self-aligning return system not only provides alignment at idle condition, the self-alignment return system of embodiments also provides alignment throughout the shift up to and including high ratio. Fixed tight belt systems today usually only allow for alignment at idle condition and suffer from misalignment everywhere else. Typical float systems usually just move the driven clutch and belt fully inward under belt pull forces which can provide the possibility for belt alignment at high ratio, but usually suffer from belt misalignment at idle condition, which may cause increased shift effort, high drag, belt wear, and vehicle creep.

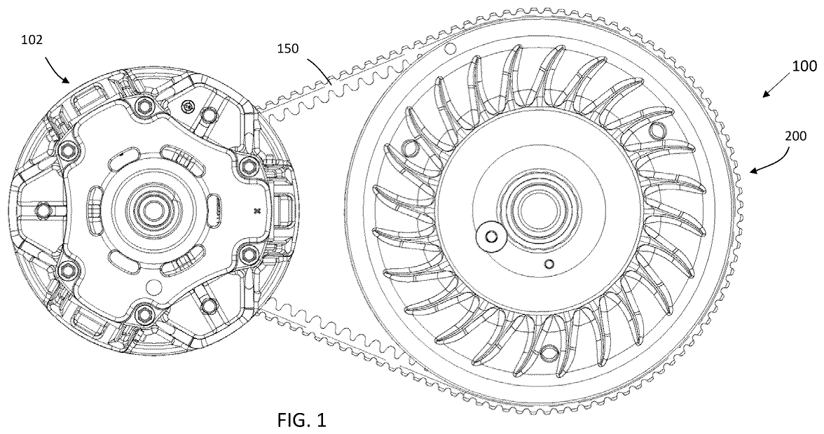

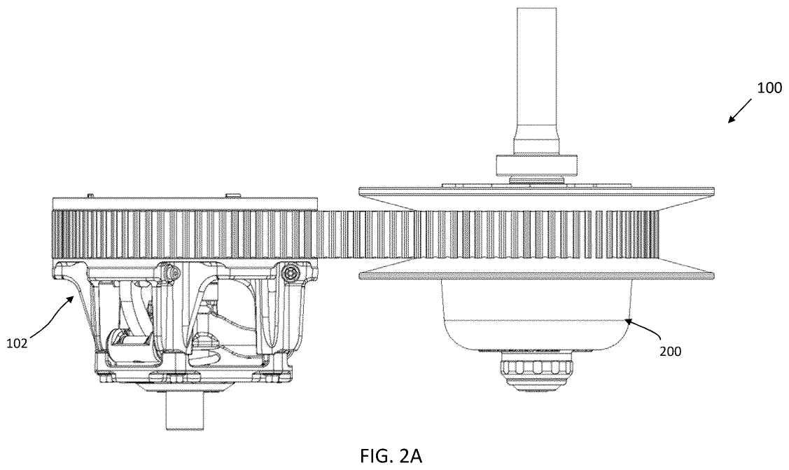

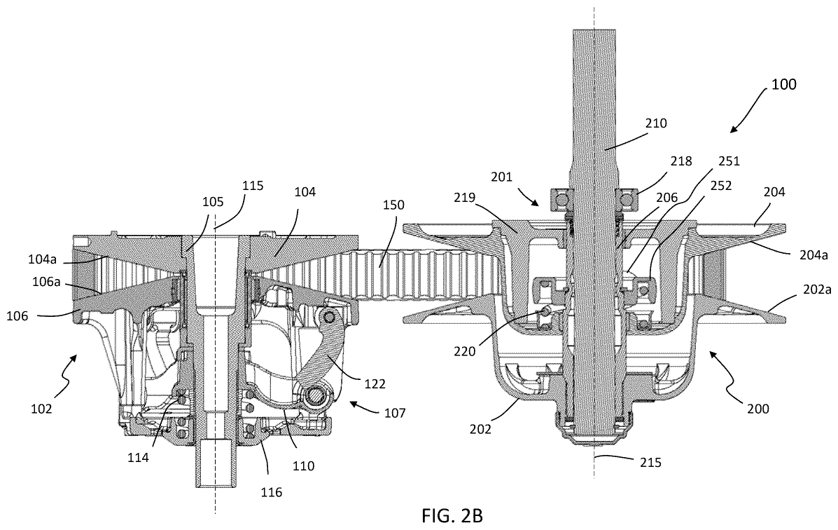

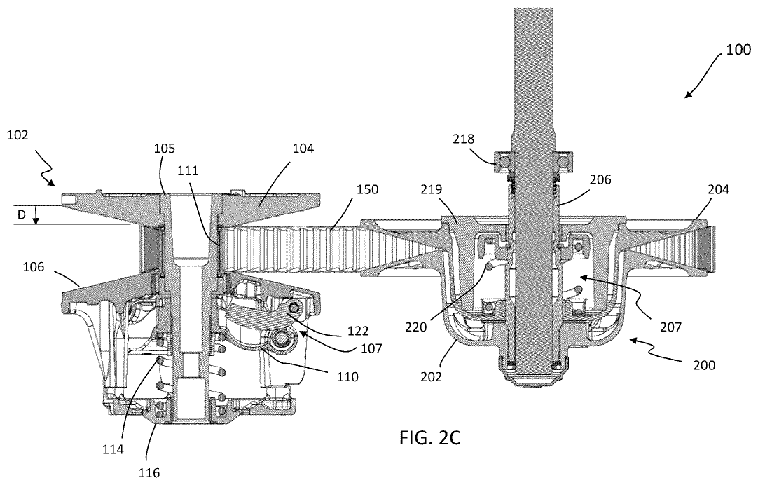

FIG. 1 illustrates a side view of a CVT 100 that includes a drive clutch 102 and a driven clutch 200 that are in torsional communication with each other via an endless loop member, which is a belt 150 in this example. The driven clutch 200 includes a self-aligning return system as described in detail below. FIG. 2A illustrates a top view of the CVT 100 in a high gear configuration.

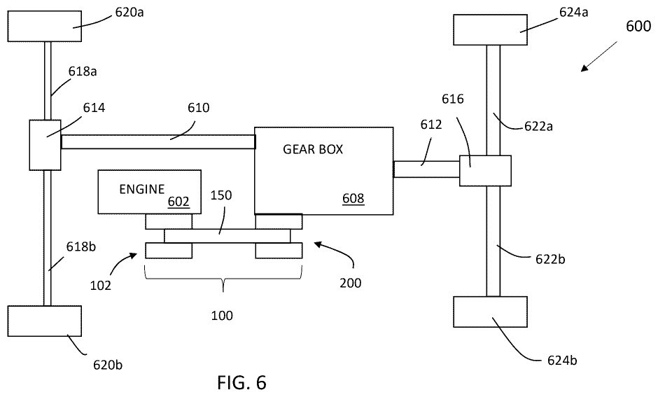

FIG. 2B illustrates a cross-sectional top view of the CVT 100 with the drive clutch 102 of the CVT 100 in a high gear configuration while FIG. 2C illustrates a cross-sectional top view of the CVT 100 with the drive clutch 102 in an idle configuration. The drive clutch 102 includes a drive fixed sheave 104 and a drive movable sheave 106. The drive fixed sheave 104 is axially fixed in a static location on a drive post 105 while the drive movable sheave 106 is axially movable on the drive post 105. A drive movable sheave portion of the drive clutch 102 includes a drive actuating system 107 that is designed to move the drive movable sheave 106 on the drive post 105 based on forces being experienced by the drive clutch such as centrifugal force due to an RPM the drive clutch is experiencing and torque forces due torsional forces the drive clutch 102 is experiencing. In the example of FIG. 2B, the drive actuation system 107 includes a drive spider 110 that is axially fixed to the drive post 105 and includes a plurality of drive arms 122 (flyweights). Each drive arm 122 is pivotally coupled to the drive movable sheave 106 and is configured to rotate to engage the drive spider 110 in response to a centrifugal force to selectively move the drive movable sheave 106 towards the drive fixed sheave 104. In the example of FIG. 2B, the drive arms 122, engaging the drive spider 110, have moved the drive movable sheave 106 towards the drive fixed sheave 104. This movement of the drive movable sheave 106 causes the belt 150 to ride up respective engaging faces of the drive movable sheave 106 and the drive fixed sheave 104 to position the belt 150 away from a drive central axis 115 resulting in a high gearing ratio. The drive actuation system 107 further includes a drive biasing member 114 having a first end that abuts the spider 110 and a second end that abuts a cover 116 of the drive movable sheave 106. The drive biasing member biases, or exerts a biasing force on, the drive movable sheave 106 away from the drive fixed sheave 104. The biasing force provided by the drive biasing member 114 is countered by the forces acting on the drive clutch 102. The drive post 105 is in rotational communication with an output of a motor, such as engine/motor 602 discussed below in view of FIG. 6.

The driven clutch 200 includes a driven fixed sheave 202 that is mounted on a driven post sleeve 206 in an axially fixed configuration. The driven post sleeve 206 is part of the self-aligning return system 205 discussed in detail below. The driven post sleeve 206 is slidably mounted on a driven post 210. The driven clutch 200 further includes a driven movable sheave 204 that is mounted on the driven post sleeve 206 in an axially movable configuration. The driven clutch 200 includes a driven actuation system 207. The driven actuation system 207 in this example, includes a driven bias member 220, which is a compression spring in this example, that is positioned to assert a biasing force to push the driven movable sheave 204 towards the driven fixed sheave 202 on the driven post sleeve 206. In one example, the driven actuation system 207 further includes a cam/roller configuration that is sensitive to torque that counters the biasing force of the driven bias member 220 in adjusting the distance between the driven movable sheave 204 and the driven fixed sheave 202. As the distance between the driven movable sheave 204 and the driven fixed sheave 202 changes, the distance between belt 150 and a central driven axis 215 of the driven clutch 200 changes.

As discussed above regarding FIG. 2B, the drive clutch 102 of the CVT 100 is illustrated in a high gear ratio configuration. In going to the high gear ratio configuration, the belt 150 has moved radially outward along the fixed conical side engaging face 104a of the drive fixed sheave 104 and the movable conical side engaging face 106a of the drive moveable sheave 106 to a maximum distance from the drive central axis 115 of the drive clutch 102. Also illustrated in FIG. 2B, the driven biasing member 220 of the driven clutch 200 is compressed between a cover of the driven movable sheave 204 and a driven spider 252. The driven spider 252, in this example, includes a plurality of arms (not shown). Each arm includes a roller 251. Each roller 251 engages a respective cam surface (not shown) of a cam 219 that is affixed to the driven movable sheave 204. The rollers 251 move along their respective cam surface based on the amount of torque the driven clutch 200 is experiencing, in one example. High torque applied to the driven clutch in this example, moves the driven movable sheave 204 away from the driven fixed sheave 202 countering a bias force provided by the driven biasing member 220.

FIG. 2C illustrates the drive clutch 102 in an idle configuration. In the idle configuration, the belt 150 has moved radially inward along the conical side engaging faces 104a and 106a of the respective drive fixed sheave 104 and drive moveable sheave 106 to a minimum distance to the drive central axis 115 of the drive clutch 102. Further in the idle configuration, an inside surface of the belt 150 rests on an idler bearing 111 so no torque is transferred or passed by the belt 150 at idle. In response to the lack of torque being transferred by belt 150, the driven biasing member 220 biases the driven movable sheave 204 towards the driven fixed sheave 202 of the driven clutch 200.

The drive clutch 102, in moving from the high gear ratio configuration (shown in FIG. 2B) to the idle configuration (shown in FIG. 2C), causes the belt 150 to move over a distance D as illustrated in FIG. 2C. To allow for the belt 150 to be properly aligned, the driven clutch 200 follows (moves over the distance D with the belt 150) in examples with the self-aligning return system 205 described below.

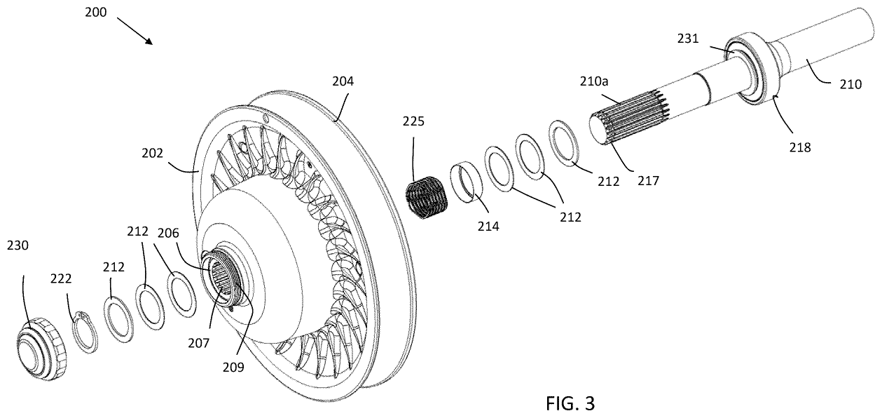

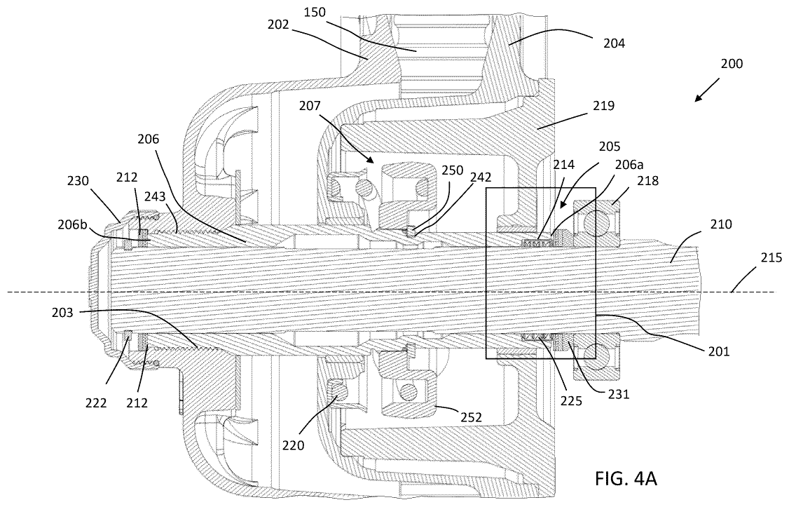

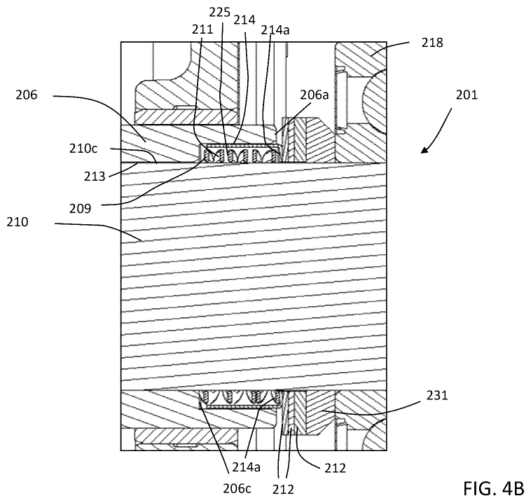

FIG. 3 illustrates a partial unassembled side view of the driven clutch 200. As illustrated, the driven clutch 200 includes the driven post 210 upon which bearing 218 is mounted. The driven post 210 includes engagement splines 210a, a spacer 231 and a clip retaining groove 217. A self-aligning return system 205 (best shown in FIG. 4A) of the driven clutch 200 includes alignment shims 212, a spring cup 214 (spring retainer), driven sleeve biasing member 225 and a retaining clip 222. The driven clutch 200 also includes an end cap 230. As best illustrated in the cross-sectional side view of the driven clutch 200 in FIG. 4A, the self-aligning return system 205 further includes a driven post sleeve 206. The driven post sleeve 206 includes an inner surface that defines a central passage. The driven post sleeve 206 is slidably mounted on the driven post 210. The driven post sleeve 206 further includes a first end 206a and a second end 206b.

In FIG. 4A, belt 150 is positioned close to the central driven axis 215 similar to the configuration of the driven clutch 200 shown in FIG. 2B. As best illustrated in FIG. 4A and close up view 201 of a portion of the self-aligning return system 205 in FIG. 4B, the driven post sleeve 206 includes an inside or inner surface 213 that defines a central passage. The driven post sleeve 206 includes an inside step portion 209 that extends radially outward from the inner surface 213 of the driven post sleeve 206. The inside step portion 209 is adjacent the first end 206a of the driven post sleeve 206. The inside step portion 209 forms a biasing shoulder 206c.

Further, a sleeve biasing cavity 211 is formed between an outer surface 210c of the driven post 210 and the inside step portion 209 of the driven post sleeve 206. A portion of the driven sleeve biasing member 225, which is a compression spring in this example, is received within the sleeve biasing cavity 211. In one example, a first end of the driven sleeve biasing member 225 within the sleeve biasing cavity 211 engages the biasing shoulder 206c of the driven post sleeve 206. A second end of the driven sleeve biasing member 225 engages an inside surface of a closed end 214a of the spring cup 214 (biasing member retainer). An outside of the closed end 214a of the spring cup 214 engages an alignment shim 212 in this example. The spring cup 214 is positioned at least in part within the sleeve biasing cavity.

The driven post sleeve 206 further includes an outer retaining groove 242 that is configured to hold a retaining clip 250 in place. The driven spider 252 with a bias seat 253 is held in place relative to the driven post sleeve 206 with the retaining clip 250. The bias seat 253 holds a first end of the driven biasing member 220. The outer retaining groove 242 is mid-positioned in the driven post sleeve 206 in this example. Proximate a second end 206b of the driven post sleeve 206 are external threads 243 that threadably engage internal threads 203 on a portion of the driven fixed sheave 202.

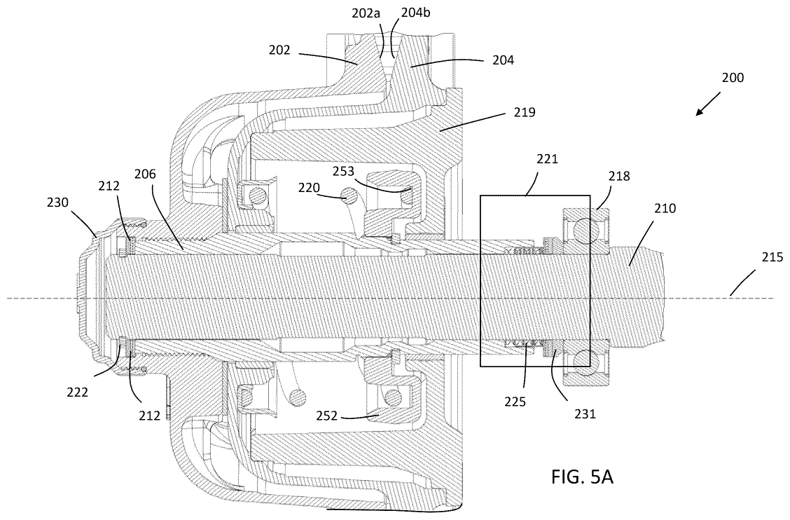

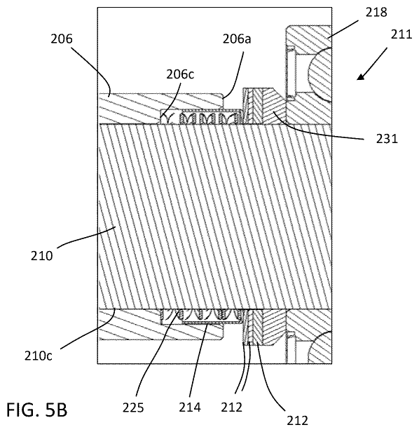

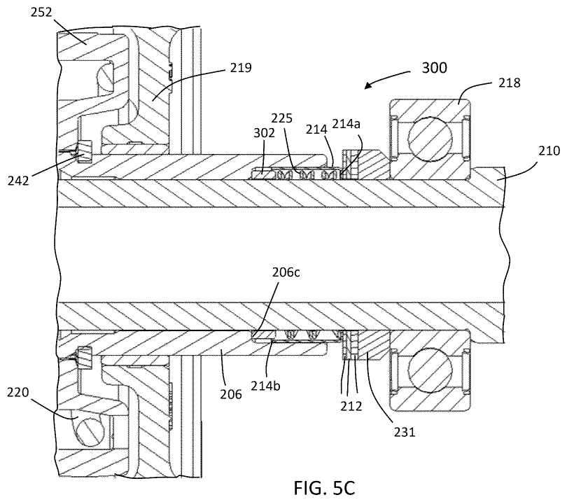

FIG. 5A illustrates the driven clutch 200 in a configuration where the belt 150 is positioned a maximum distance away from the central driven axis 215 similar to the configuration of the driven clutch 200 illustrated in FIG. 2C. This configuration may occur when the CVT 100 goes from a high gear ration to idle. Close up view 221 of a portion of the self-aligning return system 205 is illustrated in FIG. 5B. As illustrated, in this configuration, the driven sleeve biasing member 225 has uncoiled asserting a bias force the driven post sleeve 206 to move the driven post sleeve 206 on the driven post 210. The use of the self-aligning return system 205, with the driven sleeve biasing member 225, allows for the driven clutch 200 to automatically follow the drive clutch 102 by axially moving the driven fixed sheave 202 and the driven movable sheave 204 of the driven clutch 200 axially together. This movement prevents a misalignment of the belt 150 which may occur when going from a high gear ratio to idle. Further, the self-aligning return system provides a return to a home belt alignment position during idle to align the belt 150 therein preventing issues with a non-aligned belt.

Embodiments of the self-aligning return system 205 not only return the driven clutch 200 to the home belt alignment position for belt alignment at an idle condition, embodiments also cause the drive clutch 200 to follow the drive clutch 102 as the driven clutch 200 opens up. This allows for the maintaining of belt alignment throughout an entire shift ratio with belt pull forces exerted overcoming the bias return spring as needed to maintain alignment. Hence, the alignment system provided by the self-aligning return system 205 not only provides alignment at idle condition, the self-alignment return system 205 also provides alignment throughout the shift up to and including a high gear ratio.

FIG. 5C illustrates another embodiment self-aligning return system 300 that includes a biasing member spacer 302. As illustrated, the spring cup 214 includes the closed end 214a and an open end 214b. The open end 214b is positioned near the biasing shoulder 206c within the sleeve biasing cavity 211. The biasing member spacer 702 is received within the sleeve biasing cavity 211. Further, the biasing member spacer is positioned between the biasing shoulder 206c and the driven sleeve biasing member 225 to position the driven sleeve biasing member 225 to be fully contained within the spring cup 214 so that no portion of the driven sleeve biasing member 225 extends outside of the spring cup 214. This configuration prevents coils of the driven sleeve biasing member 225 from stacking up between the biasing shoulder 206c and the open end 214b of the spring cup 214. In one example the driven sleeve biasing member 225 is a wave spring.

FIG. 6 illustrates a block diagram of a vehicle 600 that includes a CVT 100 with a driven clutch 200 described above. The vehicle 600 includes an engine/motor to generate engine torque. The engine/motor 602 may be an internal combustion engine (ICE), an electric motor or any other type of engine/motor that provides engine torque. The engine/motor 602 is in torsional communication with the drive clutch 102 of the CVT 100. The drive clutch 102 is in tortional communication with the driven clutch 200 of the CVT 100 via belt 150. Belt 150 may be a rubber belt, metal belt or any other type of endlessly looped member that may be used to transfer pass torque. The driven clutch 200 is in torsional communication with a drivetrain that includes a gear box 608 in this example. The gear box 608 may include high, low, and reverse gearing for example.

The gear box 608 is in torsional communication with a rear differential 616 via rear prop shaft 612 in the example embodiment of FIG. 6. Rear wheels 624a and 624b are in turn in torsional communication with the rear differential 616 via a respective rear half-shafts 622a and 622b. The gear box 608 is also in torsional communication with a front differential 614 via a front prop shaft 610 in this example. Front wheels 620a and 620b are in turn in torsional communication with the front differential 614 via a respective rear half-shafts 618a and 618b in this example.

Further in an example, a clutch sheave belt face engaging angle of the fixed conical side engaging face 104a of drive fixed sheave 104 and a clutch sheave belt face engaging angle of the movable conical side engaging face 106a of the drive moveable sheave 106 and clutch sheave belt face engaging angles of fixed and movable conical side engaging faces 202a and 204a of the driven fixed sheave 202 and driven movable sheave 204 of the driven clutch 200 are the same. Typically, the clutch sheave belt face engaging angles on the drive sheave are different than the clutch sheave belt face engaging angles on the driven sheave. Using different clutch sheave belt face engaging angles attempts to minimize the amount of belt misalignment that can be present between the two clutches as they shift from low to high gear ratios. In particular, the axial travel of the drive clutch and the driven clutch from low to high ratio is not the same so the difference in clutch sheave belt face engaging angles helps minimize this misalignment. In embodiment described above, the driven clutch 200 and belt 150 are caused to follow the drive clutch 102 with use of the self-alignment return system 205. Because embodiments eliminate or reduce misalignments between the drive clutch 102 and driven clutch 200, the same belt face engaging angles for the drive clutch 102 and driven clutch 200 can be used which results in better belt life, reduced heat, better efficiency, etc.

### Example Embodiments

Example 1 includes a self-aligning driven clutch that includes a driven post, a self-aligning return system, a driven fixed sheave, and driven movable sheave. The self-aligning return system includes a driven post sleeve, and a driven sleeve biasing member. The driven post sleeve is slidably mounted on the driven post in an axially movable arrangement. The driven post sleeve has a first end and a second end. The driven sleeve biasing member is positioned to exert a biasing force on the driven post sleeve relative to the driven post to a home belt alignment position. The driven fixed sheave is mounted on the driven post sleeve of the self-aligning return system in an axially fixed arrangement. The driven moveable sheave slidably is mounted on the driven post sleeve of the self-aligning return system in an axially movable arrangement. The driven moveable sheave actuation system is configured to move the driven movable sheave on the driven post sleeve to selectively distance the driven movable sheave from the driven fixed sheave based on at least a force experienced by the self-aligning driven clutch.

Example 2 includes the self-aligning driven clutch of Example 1, wherein the driven post sleeve includes an inner surface that defines a central passage. The driven post sleeve has an inside step portion extending radially outward from the inner surface adjacent the first end of the driven post sleeve to form a biasing shoulder within the central passage. At least a portion of the driven sleeve biasing member is positioned within a sleeve biasing cavity formed between an outer surface of the driven post and the inside step portion of the driven post sleeve.

Example 3 includes the self-aligning driven clutch of Example 2, further includes a spring cup that is received at least in part in the sleeve biasing cavity. The driven sleeve biasing member is received within the spring cup.

Example 4 includes the self-aligning driven clutch of Example 3, wherein the spring cup includes a closed end and an open end, the open end is positioned near the biasing shoulder within the sleeve biasing cavity.

Example 5 includes the self-aligning driven clutch of Example 4, further includes a biasing member spacer received within the sleeve biasing cavity. The biasing member spacer is positioned between the biasing shoulder and the driven sleeve biasing member to position the driven sleeve biasing member to be fully contained within the spring cup.

Example 6 includes the self-aligning driven clutch of any of the Examples, wherein the driven post sleeve includes an outer surface. The outer surface includes a mid-positioned holding groove configured to receive a retaining clip positioned in part to hold a spider of the driven moveable sheave actuation system in a static location relative to the driven post sleeve.

Example 7 includes the self-aligning driven clutch of Example 6, wherein the spider includes a driven biasing member seat to hold an end of the driven biasing member.

Example 8 includes the self-aligning driven clutch of any of the Examples 1-7, wherein the second end of the driven post sleeve engages the driven fixed sheave.

Example 9 includes the self-aligning driven clutch of Example 8, wherein the second end of the driven post sleeve is threadably engaged to the driven fixed sheave.

Example 10 includes a continuously variable transmission including a drive clutch and a driven clutch. The drive clutch is configured to receive engine torque from a motor. The driven clutch is in rotational communication with the drive clutch via endless looped member. The driven clutch is configured to pass torque to a drivetrain. The driven clutch includes a driven post and a self-aligning return system. The self-aligning return system includes a driven post sleeve and a driven sleeve. The driven post sleeve is slidably mounted on the driven post in an axially movable arrangement. The driven post sleeve has a first end and a second end. A driven sleeve biasing member is positioned to exert a biasing force on the driven post sleeve relative to the driven post to a home belt alignment position. A driven fixed sheave is mounted on the driven post sleeve of the self-aligning return system in an axially fixed arrangement. A driven moveable sheave is slidably mounted on the driven post sleeve of the self-aligning return system in an axially movable arrangement. A driven moveable sheave actuation system is configured to move the driven movable sheave on the driven post sleeve to selectively distance the driven movable sheave from the driven fixed sheave based on at least a force experienced by the self-aligning driven clutch.

Example 11 includes the continuously variable transmission of Example 10, wherein the driven post sleeve includes an inner surface that defines a central passage. The driven post sleeve has an inside step portion that extends radially outward from the inner surface that is adjacent the first end of the driven post sleeve to form a biasing shoulder within the central passage. At least a portion of the driven sleeve biasing member is positioned within a sleeve biasing cavity formed between an outer surface of the driven post and the inside step portion of the driven post sleeve.

Example 12 includes the continuously variable transmission of Example 11, further including a spring cup received at least in part in the sleeve biasing cavity. The driven sleeve biasing member is received within the spring cup.

Example 13 includes the continuously variable transmission of Example 12, wherein the spring cup includes a closed end and an open end. The open end is positioned near the biasing shoulder within the sleeve biasing cavity.

Example 14 includes the continuously variable transmission of Example 13, further including a biasing member spacer that is received within the sleeve biasing cavity. The biasing member spacer is positioned between the biasing shoulder and the driven sleeve biasing member to position the driven sleeve biasing member to be fully contained within the spring cup.

Example 15 includes the continuously variable transmission of any of the Examples 10-14, wherein the driven post sleeve includes an outer surface. The outer surface includes a mid-positioned holding groove that is configured to receive a retaining clip positioned in part to hold a spider of the driven moveable sheave actuation system in a static location relative to the driven post sleeve.

Example 16 includes a vehicle that includes a motor, a drivetrain and continuously variable transmission. The motor is used to generate engine torque. The continuously variable transmission includes a drive clutch and the driven clutch. The drive clutch is configured to receive the engine torque from the motor. The driven clutch is in rotational communication with the drive clutch via endless looped member. The driven clutch is configured to pass torque to the drivetrain. The driven clutch includes a driven post and a self-aligning return system. The self-aligning return system includes a driven post sleeve, a driven sleeve biasing member, a driven fixed sheave, a driven moveable sheave and a driven moveable sheave actuation system. The driven post sleeve is slidably mounted on the driven post in an axially movable arrangement. The driven post sleeve has a first end and a second end. The driven sleeve biasing member is positioned to exert a biasing force on the driven post sleeve relative to the driven post to a home belt alignment position. The driven fixed sheave is mounted on the driven post sleeve of the self-aligning return system in an axially fixed arrangement. The driven moveable sheave is slidably mounted on the driven post sleeve of the self-aligning return system in an axially movable arrangement. The driven moveable sheave actuation system is configured to move the driven movable sheave on the driven post sleeve to selectively distance the driven movable sheave from the driven fixed sheave based on at least a force experienced by the self-aligning driven clutch.

Example 17 includes the vehicle of Example 16, wherein the driven post sleeve includes an inner surface that defines a central passage. The driven post sleeve has an inside step portion that extends radially outward from the inner surface that is adjacent the first end of the driven post sleeve to form a biasing shoulder within the central passage. At least a portion of the driven sleeve biasing member is positioned within a sleeve biasing cavity formed between an outer surface of the driven post and the inside step portion of the driven post sleeve.

Example 18 includes the vehicle of Example 17, further includes a spring cup that is received at least in part in the sleeve biasing cavity. The driven sleeve biasing member is received within the spring cup, wherein the spring cup includes a closed end and an open end. The open end is positioned near the biasing shoulder within the sleeve biasing cavity.

Example 19 includes the vehicle of Example 18, further including a biasing member spacer that is received within the sleeve biasing cavity. The biasing member spacer is positioned between the biasing shoulder and the driven sleeve biasing member to position the driven sleeve biasing member to be fully contained within the spring cup.

Example 20 includes the vehicle of any of the Examples 16-19, wherein the driven post sleeve includes an outer surface. The outer surface includes a mid-positioned holding groove that is configured to receive a retaining clip positioned in part to hold a spider of the driven moveable sheave actuation system in a static location relative to the driven post sleeve.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A self-aligning driven clutch comprising:
a driven post;
a self-aligning return system including,
a driven post sleeve slidably mounted on the driven post in an axially movable arrangement, the driven post sleeve having a first end and a second end, and
a driven sleeve biasing member positioned to exert a biasing force on the driven post sleeve relative to the driven post to a home belt alignment position;
a driven fixed sheave mounted on the driven post sleeve of the self-aligning return system in an axially fixed arrangement;
a driven moveable sheave slidably mounted on the driven post sleeve of the self-aligning return system in an axially movable arrangement; and
a driven moveable sheave actuation system configured to move the driven movable sheave on the driven post sleeve to selectively distance the driven movable sheave from the driven fixed sheave based on at least a force experienced by the self-aligning driven clutch.

2. The self-aligning driven clutch of claim 1, wherein the driven post sleeve includes an inner surface that defines a central passage, the driven post sleeve having an inside step portion extending radially outward from the inner surface adjacent the first end of the driven post sleeve to form a biasing shoulder within the central passage, at least a portion of the driven sleeve biasing member positioned within a sleeve biasing cavity formed between an outer surface of the driven post and the inside step portion of the driven post sleeve.

3. The self-aligning driven clutch of claim 2, further comprising:
a spring cup received at least in part in the sleeve biasing cavity, the driven sleeve biasing member received within the spring cup.

4. The self-aligning driven clutch of claim 3, wherein the spring cup includes a closed end and an open end, the open end is positioned near the biasing shoulder within the sleeve biasing cavity.

5. The self-aligning driven clutch of claim 4, further comprising:
a biasing member spacer received within the sleeve biasing cavity, the biasing member spacer positioned between the biasing shoulder and the driven sleeve biasing member to position the driven sleeve biasing member to be fully contained within the spring cup.

6. The self-aligning driven clutch of claim 1, wherein the driven post sleeve includes an outer surface, the outer surface including a mid-positioned holding groove configured to receive a retaining clip positioned in part to hold a spider of the driven moveable sheave actuation system in a static location relative to the driven post sleeve.

7. The self-aligning driven clutch of claim 6, wherein the spider includes a driven biasing member seat to hold an end of the driven biasing member.

8. The self-aligning driven clutch of claim 1, wherein the second end of the driven post sleeve engages the driven fixed sheave.

9. The self-aligning driven clutch of claim 8, wherein the second end of the driven post sleeve is threadably engaged to the driven fixed sheave.

10. A continuously variable transmission comprising:
a drive clutch configured to receive engine torque from a motor; and
a driven clutch in rotational communication with the drive clutch via endless looped member, the driven clutch configured to pass torque to a drivetrain, the driven clutch including:
a driven post;
a self-aligning return system including,
a driven post sleeve slidably mounted on the driven post in an axially movable arrangement, the driven post sleeve having a first end and a second end, and
a driven sleeve biasing member positioned to exert a biasing force on the driven post sleeve relative to the driven post to a home belt alignment position;
a driven fixed sheave mounted on the driven post sleeve of the self-aligning return system in an axially fixed arrangement;
a driven moveable sheave slidably mounted on the driven post sleeve of the self-aligning return system in an axially movable arrangement; and
a driven moveable sheave actuation system configured to move the driven movable sheave on the driven post sleeve to selectively distance the driven movable sheave from the driven fixed sheave based on at least a force experienced by the self-aligning driven clutch.

11. The continuously variable transmission of claim 10, wherein the driven post sleeve includes an inner surface that defines a central passage, the driven post sleeve having an inside step portion extending radially outward from the inner surface adjacent the first end of the driven post sleeve to form a biasing shoulder within the central passage, at least a portion of the driven sleeve biasing member positioned within a sleeve biasing cavity formed between an outer surface of the driven post and the inside step portion of the driven post sleeve.

12. The continuously variable transmission of claim 11, further comprising:
a spring cup received at least in part in the sleeve biasing cavity, the driven sleeve biasing member received within the spring cup.

13. The continuously variable transmission of claim 12, wherein the spring cup includes a closed end and an open end, the open end positioned near the biasing shoulder within the sleeve biasing cavity.

14. The continuously variable transmission of claim 13, further comprising:
a biasing member spacer received within the sleeve biasing cavity, the biasing member spacer positioned between the biasing shoulder and the driven sleeve biasing member to position the driven sleeve biasing member to be fully contained within the spring cup.

15. The continuously variable transmission of claim 10, wherein the driven post sleeve includes an outer surface, the outer surface including a mid-positioned holding groove configured to receive a retaining clip positioned in part to hold a spider of the driven moveable sheave actuation system in a static location relative to the driven post sleeve.

16. A vehicle comprising:
a motor to generate engine torque;
a drivetrain; and
a continuously variable transmission including:
a drive clutch configured to receive the engine torque from the motor; and
a driven clutch in rotational communication with the drive clutch via endless looped member, the driven clutch configured to pass torque to the drivetrain, the driven clutch including:
a driven post;
a self-aligning return system including,
a driven post sleeve slidably mounted on the driven post in an axially movable arrangement, the driven post sleeve having a first end and a second end, and
a driven sleeve biasing member positioned to exert a biasing force on the driven post sleeve relative to the driven post to a home belt alignment position;
a driven fixed sheave mounted on the driven post sleeve of the self-aligning return system in an axially fixed arrangement;
a driven moveable sheave slidably mounted on the driven post sleeve of the self-aligning return system in an axially movable arrangement; and
a driven moveable sheave actuation system configured to move the driven movable sheave on the driven post sleeve to selectively distance the driven movable sheave from the driven fixed sheave based on at least a force experienced by the self-aligning driven clutch.

17. The vehicle of claim 16, wherein the driven post sleeve includes an inner surface that defines a central passage, the driven post sleeve having an inside step portion extending radially outward from the inner surface adjacent the first end of the driven post sleeve to form a biasing shoulder within the central passage, at least a portion of the driven sleeve biasing member positioned within a sleeve biasing cavity formed between an outer surface of the driven post and the inside step portion of the driven post sleeve.

18. The vehicle of claim 17, further comprising:
a spring cup received at least in part in the sleeve biasing cavity, the driven sleeve biasing member received within the spring cup, wherein the spring cup includes a closed end and an open end, the open end positioned near the biasing shoulder within the sleeve biasing cavity.

19. The vehicle of claim 18, further comprising:
a biasing member spacer received within the sleeve biasing cavity, the biasing member spacer positioned between the biasing shoulder and the driven sleeve biasing member to position the driven sleeve biasing member to be fully contained within the spring cup.

20. The vehicle of claim 16, wherein the driven post sleeve includes an outer surface, the outer surface including a mid-positioned holding groove configured to receive a retaining clip positioned in part to hold a spider of the driven moveable sheave actuation system in a static location relative to the driven post sleeve.
